(19) United States
(12) Patent Application Publication
(10) Pub. No.: US 2015/0262006 A1
(43) Pub. Date: Sep. 17, 2015

(54) MONITORING SYSTEM AND MONITORING METHOD

(71) Applicant: Panasonic Intellectual Property Management Co., Ltd., Osaka (JP)

(72) Inventors: Yasuo Yomogida, Fukuoka (JP); Kazuya Waniguchi, Fukuoka (JP); Haruo Tagawa, Fukuoka (JP); Minoru Hagio, Fukuoka (JP)

(21) Appl. No.: 14/644,052

(22) Filed: Mar. 10, 2015

(30) Foreign Application Priority Data
Mar. 17, 2014 (JP) 2014-053914

(51) Int. Cl. G06K 9/00; G06Q 30/02; H04N 7/18

(52) U.S. Cl. CPC G06K 9/00369; H04N 7/181; G06K 9/00778; G06Q 30/0272; G06Q 30/0265

(57) ABSTRACT

A monitoring system includes a number-of-people counting unit that is provided inside a railway vehicle and counts the number of deboarding passengers who deboard the railway vehicle, a first camera that is provided in a stop of the railway vehicle and captures images of deboarding passengers who deboard the railway vehicle which has arrived in a home of the stop or has arrived at the stop, and a server that stores information regarding the number of deboarding passengers counted by the number-of-people counting unit and video data regarding the deboarding passengers captured by the first camera in correlation with each other.

### BACKGROUND OF THE INVENTION

1. Field of the Invention

The present invention relates to a monitoring system and a monitoring method of monitoring the number of people deboarding a moving object such as a railway vehicle or a bus.

2. Description of the Related Art

As the related art in which states of an automatic door provided in a railway vehicle for passenger transport can be easily recognized on a monitor, there is an in-vehicle monitoring system disclosed in, for example, Japanese Patent Unexamined Publication No. 2011-119912.

In the in-vehicle monitoring system disclosed in Japanese Patent Unexamined Publication No. 2011-119912, television cameras are provided at upper parts of automatic doors on a left side and a right side of a vehicle, and image data obtained by capturing opened/closed states of the automatic doors with the television cameras is monitored in a monitoring unit of a crew's cabin. In this in-vehicle monitoring system, the television camera captures images in a range downward from a direction with the automatic door on an opposite side to the television camera as an imaging visual field.

For example, when the automatic doors are opened and closed, image data captured by turning the imaging visual field of the television camera at the upper part of one automatic door downward and image data captured by turning the imaging visual field of the television camera at the upper part of the other automatic door downward are displayed on the monitor of the crew's cabin. Consequently, in the in-vehicle monitoring system disclosed in Japanese Patent Unexamined Publication No. 2011-119912, information pieces regarding the number of boarding and deboarding passengers, age group, sex, and the like can be easily obtained through an image process on the basis of states of the automatic doors and can thus be easily recognized from the monitor of the crew's cabin.

However, in the configuration disclosed in Japanese Patent Unexamined Publication No. 2011-119912, since the television cameras are provided inside the railway vehicle, for example, in a situation in which the railway vehicle is crowded with many passengers, there is a possibility that it may be hard to accurately determine at least the number of boarding and deboarding passengers. For example, in a situation in which the railway vehicle is crowded, in a case where a person within the imaging visual field of the television camera turns his/her back to the television camera, or an image of only the back of his/her head is captured, it may be unclear whether the person is a person (for example, a child) or baggage, and thus there is a possibility that it may be hard to accurately determine the person as a person.

### SUMMARY OF THE INVENTION

According to the present invention, there is provided a monitoring system including a number-of-people counting unit that is provided inside a moving object and counts the number of people deboarding the moving object; a first camera that is provided in a location in which people deboard the moving object and captures images of people who deboard the moving object which has arrived at a predetermined position of the location or has arrived at the location; and a server that stores information regarding the number of people counted by the number-of-people counting unit and video data regarding the people captured by the first camera in correlation with each other.

According to the present invention, an image captured by a camera provided in a home is correlated with a result of counting the number of people deboarding a railway vehicle, and thus it is possible to determine the number of passengers deboarding the railway vehicle with high accuracy.

### BRIEF DESCRIPTION OF DRAWINGS

FIG. 1 is a summary explanation diagram schematically illustrating a system configuration of a monitoring system of each exemplary embodiment;

FIG. 2 is a diagram illustrating an operation summary according to a first configuration example of a monitoring system of a first exemplary embodiment;

FIG. 3 is a diagram illustrating an operation summary according to a second configuration example of the monitoring system of the first exemplary embodiment;

FIG. 4A is a block diagram illustrating an example of a hardware configuration of a server of the monitoring system of the first exemplary embodiment;

FIG. 4B is a block diagram illustrating an example of a hardware configuration of a data management device of the monitoring system of the first exemplary embodiment;

FIG. 5A is a diagram illustrating an example (a bar graph of the number of deboarding passengers) of time zone-basis statistically processed data in the monitoring system of the first exemplary embodiment;

FIG. 5B is a diagram illustrating video data which is displayed (reproduced) through a double-click operation on the bar illustrated in FIG. 5A;

FIG. 6A is a diagram illustrating an example (a bar graph of the number of deboarding passengers) of station-basis statistically processed data in the monitoring system of the first exemplary embodiment;

FIG. 6B is a diagram illustrating video data which is displayed (reproduced) through a double-click operation on the bar illustrated in FIG. 6A;

FIG. 7 is a diagram illustrating an example (a map of the number of deboarding passengers) of time zone-basis statistically processed data for each stop in the monitoring system of the first exemplary embodiment;

FIG. 8 is a diagram illustrating an operation summary of a monitoring system of a second exemplary embodiment;

FIG. 9 is a diagram illustrating an operation summary according to a first configuration example of the monitoring system of the second exemplary embodiment;

FIG. 10 is a diagram illustrating an operation summary according to a second configuration example of the monitoring system of the second exemplary embodiment;

FIG. 11 is a diagram illustrating an operation summary according to a third configuration example of the monitoring system of the second exemplary embodiment;

FIG. 12 is a flowchart illustrating a first operation example of the monitoring system of the second exemplary embodiment;

FIG. 13 is a flowchart illustrating a second operation example of the monitoring system of the second exemplary embodiment;

FIG. 14 is a flowchart illustrating a third operation example of the monitoring system of the second exemplary embodiment;

FIG. 15A is a diagram illustrating an example of delivery advertisement data which is displayed on an advertisement display device provided in a home related to a railway vehicle bound for “ZZZ” Station from 7 a.m. to 10:30 a.m.;

FIG. 15B is a diagram illustrating an example of delivery advertisement data which is displayed on advertisement display device provided inside a railway vehicle bound for “ZZZ” Station from 7 a.m. to 10:30 a.m.;

FIG. 16A is a diagram illustrating an example of an advertisement which is displayed on an advertisement display device provided in a home related to a railway vehicle bound for “WWW” Station from 2 p.m. to 4:30 p.m.;

FIG. 16B is a diagram illustrating an example of delivery advertisement data which is displayed on an advertisement display device provided inside a railway vehicle bound for “WWW” Station from 2 p.m. to 4:30 p.m.; and

FIG. 17 is an operation summary diagram illustrating a fourth operation example of the monitoring system of the second exemplary embodiment.

### DETAILED DESCRIPTION OF THE PREFERRED EMBODIMENTS

Hereinafter, each exemplary embodiment of a monitoring system and a monitoring method related to the present invention will be described with reference to the drawings.

### Summary of Configuration of Monitoring System of Each Exemplary Embodiment

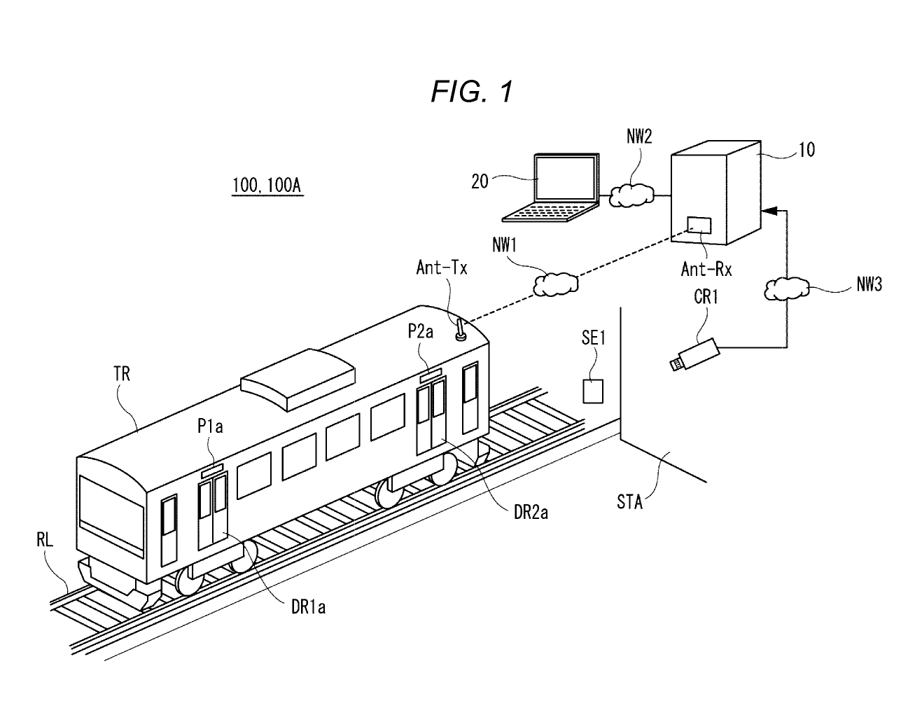

First, prior to description of monitoring system 100 of a first exemplary embodiment, a summary of a system configuration of monitoring systems 100 and 100A will be described with reference to FIG. 1. FIG. 1 is a summary explanation diagram schematically illustrating a system configuration of monitoring systems 100 and 100A of the respective exemplary embodiments.

In monitoring systems 100 and 100A of the respective exemplary embodiments illustrated in FIG. 1, in a case where arrival of railway vehicle TR travelling on rails RL at stop STA is detected by arrival sensor SE1 which is provided in stop STA in advance, number-of-people counting units P1a and P2a count the number of passengers deboarding (hereinafter, referred to as “deboarding passengers”) deboarding railway vehicle TR via automatic doors DR1a and DR2a. Information regarding the number of deboarding passengers counted by number-of-people counting units P1a and P2a is transmitted from transmission antenna Ant-Tx which is provided in railway vehicle TR in advance and is received by reception antenna Ant-Rx via network NW1 of server 10.

Similarly, in a case where arrival of railway vehicle TR at stop STA is detected by arrival sensor SE1 which is provided in stop STA in advance, camera CR1 which is provided in a home of stop STA in advance captures images of deboarding passengers deboarding railway vehicle TR via automatic doors DR1a and DR2a. Video data regarding the deboarding passengers obtained through image capturing by camera CR1 is transmitted to server 10 via network NW3. In addition, arrival sensor SE1 may be included in monitoring system 100 of the first exemplary embodiment, or may be omitted.

Server 10 receives at least the information regarding the number of deboarding passengers at stop STA, transmitted from railway vehicle TR, and the video data regarding the deboarding passengers obtained through image capturing by camera CR1, and stores at least the information regarding the number of deboarding passengers and the video data regarding the deboarding passengers in correlation with each other. Server 10 generates statistically processed data which will be described later by using the information regarding the number of deboarding passengers at stop STA and the video data regarding the deboarding passengers in response to a predetermined input operation performed by a monitoring person who operates monitoring device 20, and displays the statistically processed data on a display unit (for example, display DP) of monitoring device 20 via network NW2.

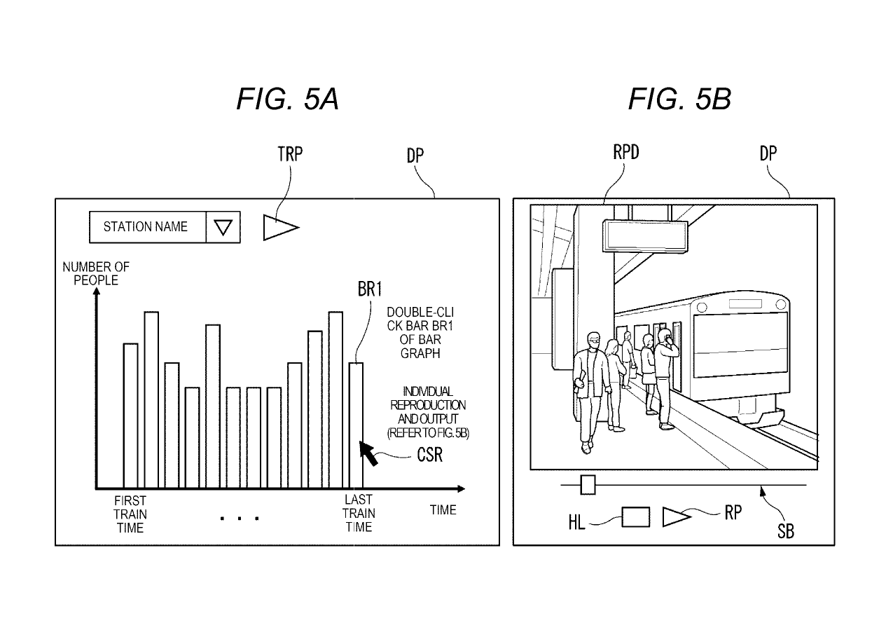

Monitoring device 20 is configured by using, for example, a stationary personal computer (PC) provided in a monitoring/control office of the stop, but is not limited to the stationery PC, and may be configured by using, for example, a portable data communication apparatus (a tablet terminal or a smartphone). Monitoring device 20 is, for example, a monitor used by a monitoring person of monitoring system 100, and includes an operation unit (not illustrated) which receives an input operation from the monitoring person, and display DP (refer to FIG. 5A) which displays statistically processed data (which will be described later) generated by server 10. Monitoring device 20 displays the statistically information data generated by server 10 on display DP in response to a predetermined input operation from the monitoring person.

### First Exemplary Embodiment

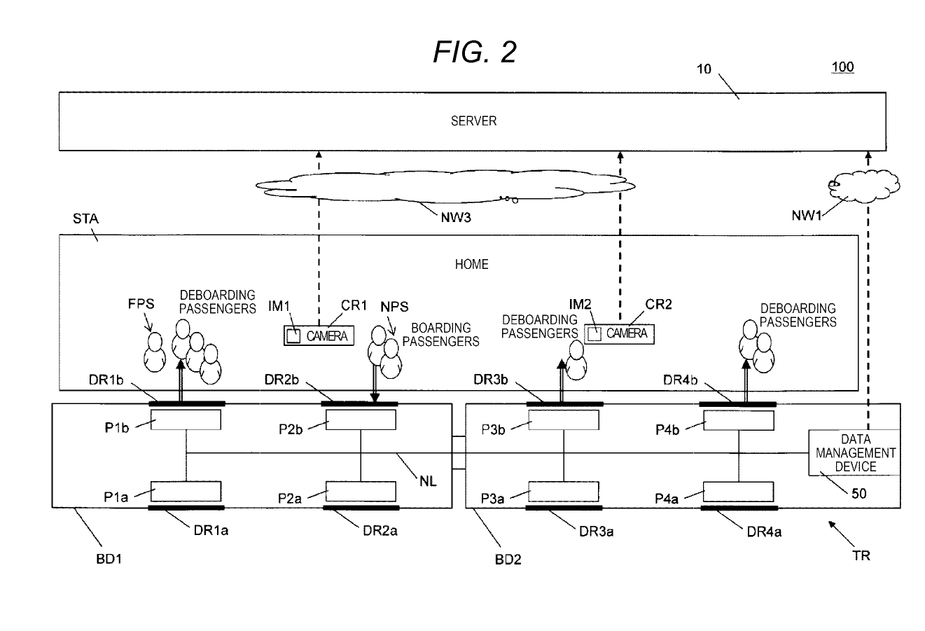

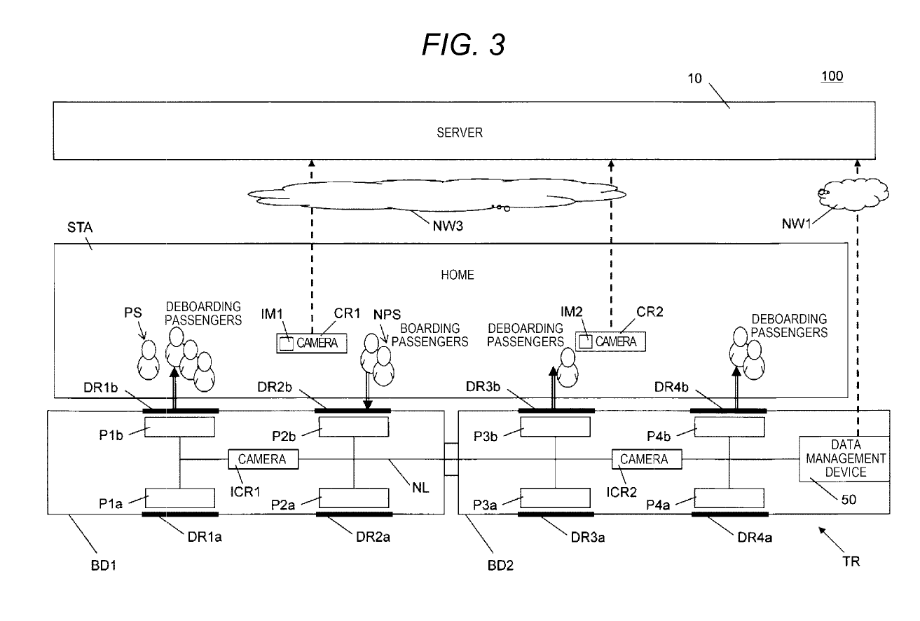

FIG. 2 is a diagram illustrating an operation summary according to a first configuration example of monitoring system 100 of the first exemplary embodiment. FIG. 3 is a diagram illustrating an operation summary according to a second configuration example of monitoring system 100 of the first exemplary embodiment. FIGS. 2 and 3 illustrate, for example, a situation in which railway vehicle TR arrives at stop STA and automatic doors DR1b, DR2b, DR3b and DR4b are ready to be opened.

Monitoring system 100 illustrated in FIG. 2 includes number-of-people counting units P1a, P1b, P2a, P2b, P3a, P3b, P4a and P4b, data management device 50, cameras CR1 and CR2, and server 10.

Number-of-people counting units P1a, P1b, P2a, P2b, P3a, P3b, P4a and P4b are provided in railway vehicle TR, and count deboarding passengers FPS deboarding or boarding passengers NPS boarding railway vehicle TR via automatic doors DR1b, DR2b, DR3b and DR4b or automatic doors DR1a, DR2a, DR3a and DR4a, for example, in a case where railway vehicle TR arrives at stop STA and stops at a predetermined position of the home. Number-of-people counting units P1a, P1b, P2a, P2b, P3a, P3b, P4a and P4b output the counted number of people, that is, information regarding the number of deboarding passengers FPS or boarding passengers NPS to data management device 50 via data transmission cable NL.

Data management device 50 acquires the counted number which is output from number-of-people counting units P1a, P2a, P3a, and P4a or number-of-people counting units P1b, P2b, P3b and P4b, that is, the information regarding the number of deboarding passengers FPS or boarding passengers NPS, and transmits the information regarding the number of deboarding passengers FPS or boarding passengers NPS to server 10 via network NW1. Network NW1 is a wireless network, and is, for example, a wireless local area network (LAN) or a wireless wide area network (WAN).

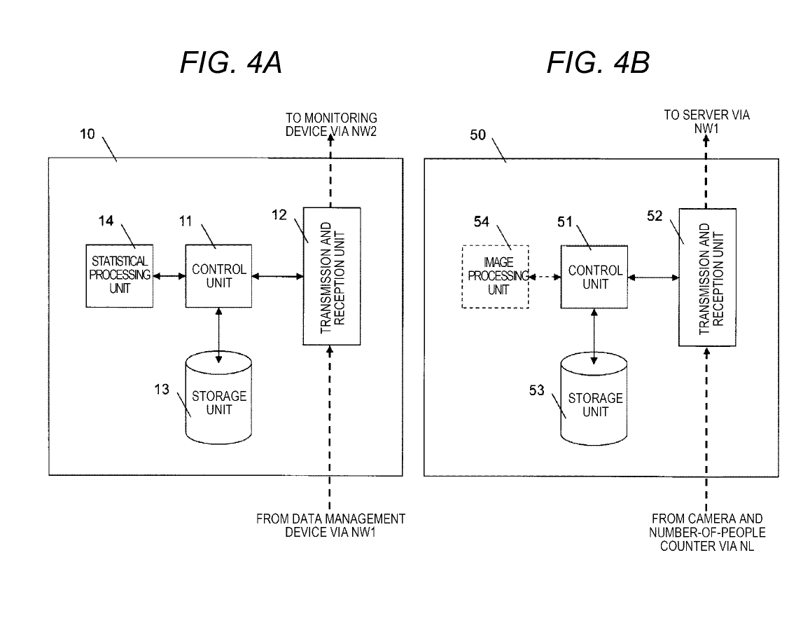

Data management device 50 may transmit the information to server 10 each time output of number-of-people counting units P1a, P2a, P3a, and P4a or number-of-people counting units P1b, P2b, P3b and P4b is acquired when railway vehicle TR stops at stop STA, and may collectively transmit the information to server 10 at a predetermined timing. A specific hardware configuration of data management device 50 will be described with reference to FIG. 4B.

Cameras CR1 and CR2, which have a clock function, are provided at stop STA of railway vehicle TR, and capture images of deboarding passengers FPS deboarding or boarding passengers NPS boarding railway vehicle TR which has arrived in the home of stop STA or arrived at stop STA via the automatic doors (for example, automatic doors DR1b, DR2b, DR3b and DR4b in FIG. 2). In monitoring systems 100 and 100A of the respective exemplary embodiments, it is assumed that a relationship between identification information regarding the cameras and the stop is predefined, and the identification information regarding cameras CR1 and CR2 is correlated with information (for example, information regarding a stop name) indicating the stop.

Cameras CR1 and CR2 perform an image process (for example, a person's face detection process) on video data of deboarding passengers FPS, obtained through image capturing by cameras CR1 and CR2, in image processing units IM1 and IM2, so as to detect deboarding passengers FPS deboarding railway vehicle TR via the automatic doors, and determines the number of deboarding passengers FPS. Here, it is considered that deboarding passengers deboarding railway vehicle TR are likely to be directed toward the front direction (that is, a direction from railway vehicle TR to the home of stop STA) although there are individual differences. Therefore, cameras CR1 and CR2 can accurately determine the number of deboarding passengers FPS from an image processing result performed by image processing units IM1 and IM2.

Cameras CR1 and CR2 transmit the deboarding time information (including the identification information regarding cameras CR1 and CR2, which is also the same for the following description) at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2 to server 10 via network NW3. Network NW3 is a wireless network, and is, for example, a wireless LAN or a wireless WAN.

As illustrated in FIG. 3, in monitoring system 100 of the present exemplary embodiment, cameras ICR1 and ICR2 may be additionally provided inside railway vehicle TR. For example, while railway vehicle TR has arrived at stop STA and is stopping thereat, cameras ICR1 and ICR2 capture images of the inside of railway vehicle TR. Cameras ICR1 and ICR2 may continuously capture images of the inside of railway vehicle TR while railway vehicle TR is traveling. Cameras ICR1 and ICR2 output video data regarding the inside of railway vehicle TR obtained through image capturing to data management device 50. In this case, data management device 50 transmits the video data regarding the inside of railway vehicle TR captured by cameras ICR1 and ICR2 via network NW1.

Server 10 receives the information regarding the number of deboarding passengers FPS or boarding passengers NPS, or a set of the information regarding the number of deboarding passengers FPS or boarding passengers NPS and the video data regarding the inside of railway vehicle TR captured by cameras ICR1 and ICR2, transmitted from data management device 50. Server 10 receives the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, transmitted from cameras CR1 and CR2.

Server 10 stores the information regarding the number of deboarding passengers FPS or boarding passengers NPS, or the set of the information regarding the number of deboarding passengers FPS or boarding passengers NPS and the video data regarding the inside of railway vehicle TR captured by cameras ICR1 and ICR2, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, in correlation with each other. A specific hardware configuration of server 10 will be described later with reference to FIG. 4A.

In FIGS. 2 and 3, for simplification of description, railway vehicle TR is made up of two cars including first and second cars BD1 and BD2, but railway vehicle TR of the present exemplary embodiment is not limited to two cars including first and second cars BD1 and BD2. Data management device 50 is provided in the right car of railway vehicle TR illustrated in FIGS. 2 and 3, but may be provided in the left car.

FIG. 4A is a block diagram illustrating an example of a hardware configuration of server 10 of monitoring system 100 according to the first exemplary embodiment. FIG. 4B is a block diagram illustrating an example of a hardware configuration of data management device 50 of monitoring system 100 according to the first exemplary embodiment. Server 10 illustrated in FIG. 4A includes control unit 11, transmission and reception unit 12, storage unit 13, and statistical processing unit 14. Data management device 50 illustrated in FIG. 4B includes control unit 51, transmission and reception unit 52, storage unit 53, and image processing unit 54.

In FIG. 4A, control unit 11 is configured by using, for example, a central processing unit (CPU), a micro-processing unit (MPU), or a digital signal processor (DSP), and a random access memory (RAM), and collectively controls operations of the respective units of server 10, so as to control a calculation process of information or data, inputting and outputting processes, a storage process, and other operations.

Transmission and reception unit 12 receives the information regarding the number of deboarding passengers FPS or boarding passengers NPS, or the set data of the information regarding the number of deboarding passengers FPS or boarding passengers NPS and the video data regarding the inside of railway vehicle TR captured by cameras ICR1 and ICR2, transmitted from data management device 50. Transmission and reception unit 12 receives the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, transmitted from the cameras CR1 and CR2. Transmission and reception unit 12 transmits statistically processed data generated by statistical processing unit 14 to monitoring device 20 in response to a predetermined input operation from the monitoring person operating monitoring device 20.

Storage unit 13 is configured by using, for example, a read only memory (ROM), and a hard disk or a flash memory, and stores various information pieces or data items received by transmission and reception unit 12.

Statistical processing unit 14 is configured by using, for example, a dedicated processing circuit (hardware), and generates various statistically processed data items which will be described later, by using the information regarding the number of deboarding passengers FPS or boarding passengers NPS, or the set data of the information regarding the number of deboarding passengers FPS or boarding passengers NPS and the video data regarding the inside of railway vehicle TR captured by cameras ICR1 and ICR2, transmitted from data management device 50, and the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, transmitted from the cameras CR1 and CR2.

Statistical processing unit 14 may generate various statistically processed data items when acquiring and updating the information regarding the number of deboarding passengers FPS or boarding passengers NPS, or the set data of the information regarding the number of deboarding passengers FPS or boarding passengers NPS and the video data regarding the inside of railway vehicle TR captured by cameras ICR1 and ICR2, transmitted from data management device 50, and the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, transmitted from the cameras CR1 and CR2. Alternatively, statistical processing unit 14 may generate various statistically processed data items in response to an input operation from the monitoring person operating monitoring device 20.

Statistical processing unit 14 stores the statistically processed data in storage unit 13. In FIG. 4A, statistical processing unit 14 is illustrated as a configuration separate from control unit 11, but may be included in control unit 11. In this case, statistical processing unit 14 functions as application software installed in server 10.

In FIG. 4B, control unit 51 is configured by using, for example, a central processing unit (CPU), a micro-processing unit (MPU), or a digital signal processor (DSP), and a random access memory (RAM), and collectively controls operations of the respective units of data management device 50, so as to control a calculation process of information or data, inputting and outputting processes, a storage process, and other operations.

Transmission and reception unit 52 acquires the counted number which is output from number-of-people counting units P1a, P2a, P3a, and P4a or number-of-people counting units P1b, P2b, P3b and P4b, that is, the information regarding the number of deboarding passengers FPS or boarding passengers NPS, and transmits the information regarding the number of deboarding passengers FPS or boarding passengers NPS to server 10 via network NW1 (refer to FIG. 2).

In a case where cameras ICR1 and ICR2 are provided inside railway vehicle TR, transmission and reception unit 52 transmits the counted number which is output from number-of-people counting units P1a, P2a, P3a, and P4a or number-of-people counting units P1b, P2b, P3b and P4b, that is, the information regarding the number of deboarding passengers FPS or boarding passengers NPS, and transmits the information regarding the number of deboarding passengers FPS or boarding passengers NPS and video data regarding the inside of railway vehicle TR captured by cameras CR1 and CR2 to server 10 via network NW1 (refer to FIG. 3).

Storage unit 53 is configured by using, for example, a ROM, and a hard disk or a flash memory, and stores various information pieces or data items acquired by transmission and reception unit 52, or information pieces or data items acquired by transmission and reception unit 52 and information (for example, an image processing result of video data regarding the inside of railway vehicle TR) output from image processing unit 54.

For example, in a case where cameras ICR1 and ICR2 are provided inside railway vehicle TR, image processing unit 54 performs a predetermined image process (for example, detection of a person, or detection of a face) the video data regarding the inside of railway vehicle TR captured by cameras ICR1 and ICR2, and stores data regarding an image processing result (for example, an image processing result of detecting a person from the video data) in storage unit 53. Image processing unit 54 may not be included in data management device 50.

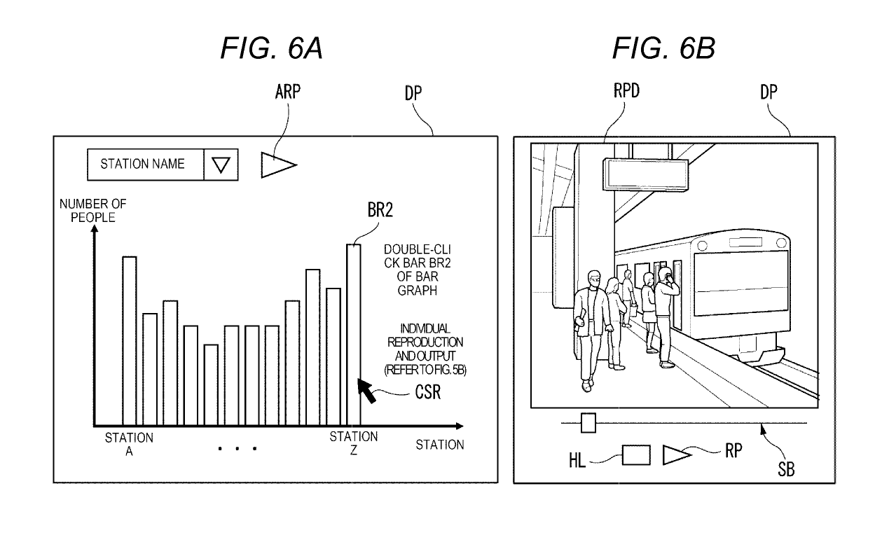

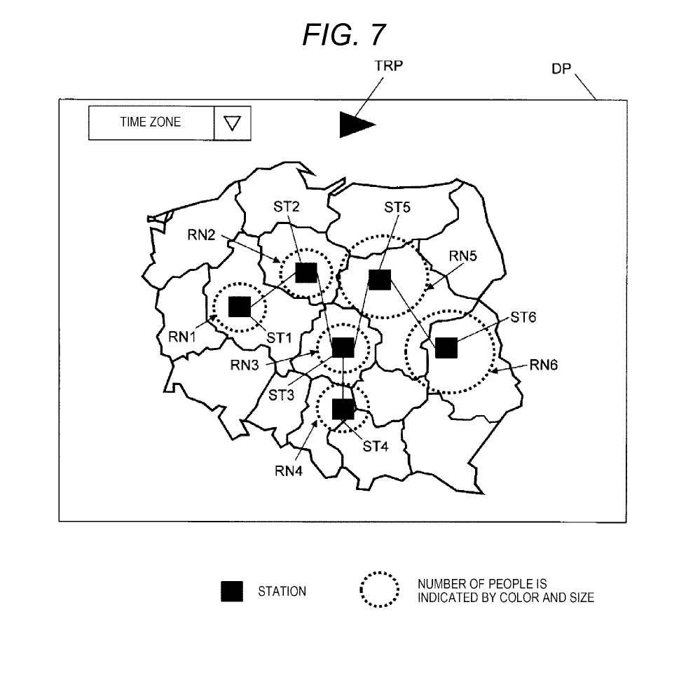

Next, with reference to FIGS. 5A, 5B, 6A, 6B and 7, a description will be made of an example of a statistical process in statistical processing unit 14 of server 10. FIG. 5A is a diagram a diagram illustrating an example (a bar graph of the number of deboarding passengers) of time zone-basis statistically processed data in the monitoring system of the first exemplary embodiment. FIG. 5B is a diagram illustrating video data which is displayed (reproduced) through a double-click operation on the bar illustrated in FIG. 5A. FIG. 6A is a diagram illustrating an example (a bar graph of the number of deboarding passengers) of station-basis statistically processed data in the monitoring system of the first exemplary embodiment. FIG. 6B is a diagram illustrating video data which is displayed (reproduced) through a double-click operation on the bar illustrated in FIG. 6A. FIG. 7 is a diagram illustrating an example (a map of the number of deboarding passengers) of time zone-basis statistically processed data for each stop in the monitoring system of the first exemplary embodiment.

In FIG. 5A, the number of deboarding passengers FPS from the first train time to the last train time of railway vehicle TR in a specific stop is indicated by a bar graph. In other words, as a first statistical process example, statistical processing unit 14 generates first statistically processed data indicating a time zone-basis number of deboarding passengers FPS for each stop by using the information regarding the number of deboarding passengers FPS or boarding passengers NPS, or the set data of the information regarding the number of deboarding passengers FPS or boarding passengers NPS and the video data regarding the inside of railway vehicle TR captured by cameras ICR1 and ICR2, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2.

Statistical processing unit 14 correlates video data of deboarding passengers FPS in a time zone indicated by each bar, with a bar of a certain bar graph indicating a time zone-basis number of deboarding people illustrated in FIG. 5A, so as to generate the first statistically processed data. Therefore, for example, in a case where bar BR1 at the right end is double-clicked with cursor CSR by the monitoring person in the bar graph, illustrated in FIG. 5A, displayed on display DP of monitoring device 20, control unit 11 of server 10 reads video data of deboarding passengers FPS in a time zone corresponding to bar BR1 indicated by cursor CSR from storage unit 13, and displays (reproduces) the read video data on display DP of monitoring device 20 (refer to FIG. 5B).

FIG. 5B illustrates a situation in which video data captured by a camera (for example, camera CR1) in a time zone near the last train time of a specific stop is displayed (reproduced) in response to the double-click operation on bar BR1 illustrated in FIG. 5A. The video data is displayed (reproduced) on display screen RPD of FIG. 5B for displaying video data, seek bar SB is displayed on a lower side of display screen RPD, and stop button HL and reproduction button RP are displayed on a lower side of seek bar SB. A length of seek bar SB corresponds to the capturing time of the video data captured by the camera (for example, camera CR1), and indicates a specific time.

If time zone-basis forward reproduction button TRP illustrated in FIG. 5A is clicked, video data of deboarding passengers FPS in each time zone from the first train time to the last train time illustrated in FIG. 5A is sequentially displayed (reproduced) on display DP of monitoring device 20. FIG. 5A may illustrate not only the time zone-basis transition of the number of deboarding passengers FPS but a time zone-basis transition of the number of boarding passengers NPS.

Consequently, in monitoring system 100 of the present exemplary embodiment, the information regarding the number of deboarding passengers FPS or boarding passengers NPS, or the set data of the information regarding the number of deboarding passengers FPS or boarding passengers NPS and the video data regarding the inside of railway vehicle TR, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, are stored in server 10 in correlation with each other. Therefore, the monitoring person can accurately understand a transition of the time zone-basis number of deboarding passengers FPS in a specific stop. In addition, it is possible to display the number of deboarding passengers FPS in a designated time zone on monitoring device 20 individually and in detail through a simple operation such as a double-click operation on a bar of the bar graph.

In FIG. 6A, the number of deboarding passengers FPS for each stop (for example, station A to station Z) of railway vehicle TR in a certain time zone is indicated by a bar graph. In other words, as a second statistical process example, statistical processing unit 14 generates second statistically processed data indicating a stop-basis number of deboarding passengers FPS for each time zone by using the information regarding the number of deboarding passengers FPS or boarding passengers NPS, or the set data of the information regarding the number of deboarding passengers FPS or boarding passengers NPS and the video data regarding the inside of railway vehicle TR, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2.

Statistical processing unit 14 correlates video data of deboarding passengers FPS in a stop indicated by each bar, with a bar of a certain bar graph indicating a stop-basis number of deboarding people illustrated in FIG. 6A, so as to generate the second statistically processed data. Therefore, for example, in a case where bar BR2 at the right end is double-clicked with cursor CSR by the monitoring person in the bar graph, illustrated in FIG. 6A, displayed on display DP of monitoring device 20, control unit 11 of server 10 reads video data of deboarding passengers FPS in a stop corresponding to bar BR2 indicated by cursor CSR from storage unit 13, and displays (reproduces) the read video data on display DP of monitoring device 20 (refer to FIG. 6B).

FIG. 6B illustrates a situation in which video data captured by a camera (for example, camera CR1) in a stop (for example, station Z) in a specific time zone is displayed (reproduced) in response to the double-click operation on bar BR2 illustrated in FIG. 6A. The video data is displayed (reproduced) on display screen RPD of FIG. 6B for displaying video data, seek bar SB is displayed on a lower side of display screen RPD, and stop button HL and reproduction button RP are displayed on a lower side of seek bar SB. A length of seek bar SB corresponds to the capturing time of the video data captured by the camera (for example, camera CR1), and indicates a specific time.

If stop-basis forward reproduction button ARP illustrated in FIG. 6A is clicked, video data of deboarding passengers FPS in each stop from station A to station Z illustrated in FIG. 6A is sequentially displayed (reproduced) on display DP of monitoring device 20. FIG. 6A may illustrate not the stop-basis transition of the number of deboarding passengers FPS but a stop-basis transition of the number of boarding passengers NPS.

Consequently, in monitoring system 100 of the present exemplary embodiment, the information regarding the number of deboarding passengers FPS or boarding passengers NPS, or the set data of the information regarding the number of deboarding passengers FPS or boarding passengers NPS and the video data regarding the inside of railway vehicle TR captured by cameras ICR1 and ICR2, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, are stored in server 10 in correlation with each other. Therefore, the monitoring person can accurately understand a transition of the stop-basis number of deboarding passengers FPS in a specific time zone. In addition, it is possible to display the number of deboarding passengers FPS in a designated stop on monitoring device 20 individually and in detail through a simple operation such a double-click operation on a bar of the bar graph.

In FIG. 7, the number of deboarding passengers FPS in each stop of certain railway vehicle TR is indicated by a dotted circle. Specifically, in FIG. 7, the number of deboarding passengers FPS in stops ST1, ST2, ST3, ST4, ST5 and ST6 are respectively indicated by dotted circles RN1, RN2, RN3, RN4, RN5 and RN6.

Dotted circles RN1, RN2, RN3, RN4, RN5 and RN6 indicate the number of deboarding passengers FPS with a color of the dotted circle or a size of the dotted circle. For example, it can be seen from FIG. 7 that the number of deboarding passengers FPS is largest in stops ST5 and ST6, and the number of deboarding passengers FPS in stops ST1, ST2, ST3 and ST4 is smallest.

For example, if time zone-basis forward reproduction button TRP illustrated in FIG. 7 is clicked by the monitoring person, video data of deboarding passengers FPS in each stop illustrated in FIG. 7 is sequentially displayed (reproduced) on display DP of monitoring device 20. FIG. 7 may illustrate not the stop-basis transition of the number of deboarding passengers FPS but a stop-basis transition of the number of boarding passengers NPS.

Consequently, in monitoring system 100 of the present exemplary embodiment, the information regarding the number of deboarding passengers FPS or boarding passengers NPS, or the set of the information regarding the number of deboarding passengers FPS or boarding passengers NPS and the video data regarding the inside of railway vehicle TR captured by cameras ICR1 and ICR2, the deboarding time information at which deboarding passengers FPS deboard railway vehicle TR, the video data obtained through image capturing for a predetermined period of time (for example, several minutes before and after the automatic doors are opened) including the time at which the automatic doors (for example, automatic doors DR1b, DR2b, DR3b and DR4b in FIG. 2) of railway vehicle TR are opened, and the image process result (that is, a result of detecting the number of deboarding passengers FPS) performed by image processing units IM1 and IM2, are stored in server 10 in correlation with each other. Therefore, the monitoring person can accurately and easily understand a transition of the stop-basis number of deboarding passengers FPS or boarding passengers NPS in relation to specific railway vehicle TR in a bird's-eye view.

As mentioned above, in monitoring system 100 of the present exemplary embodiment, the number of deboarding passengers deboarding railway vehicle TR is counted by number-of-people counting units P1a, P2a, P3a, and P4a (or number-of-people counting units P1b, P2b, P3b and P4b) provided in railway vehicle TR, and images of deboarding passengers deboarding railway vehicle TR which has arrived in the home of stop STA or at stop STA are captured by cameras CR1 and CR2. Information regarding the number of deboarding passengers deboarding railway vehicle TR and video data regarding the deboarding passengers are stored in server 10 in correlation with each other.

Consequently, since the video data regarding the deboarding passengers obtained through image capturing performed by cameras CR1 and CR2 provided in the home of stop STA is correlated with the information regarding number of deboarding passengers deboarding railway vehicle TR which has arrived at stop STA, monitoring system 100 can determine the number of deboarding passengers deboarding railway vehicle TR with high accuracy, focusing on the fact that the deboarding passengers deboarding railway vehicle TR are likely to be directed toward the front direction (that is, a direction from the railway vehicle to the home of the stop).

### Second Exemplary Embodiment

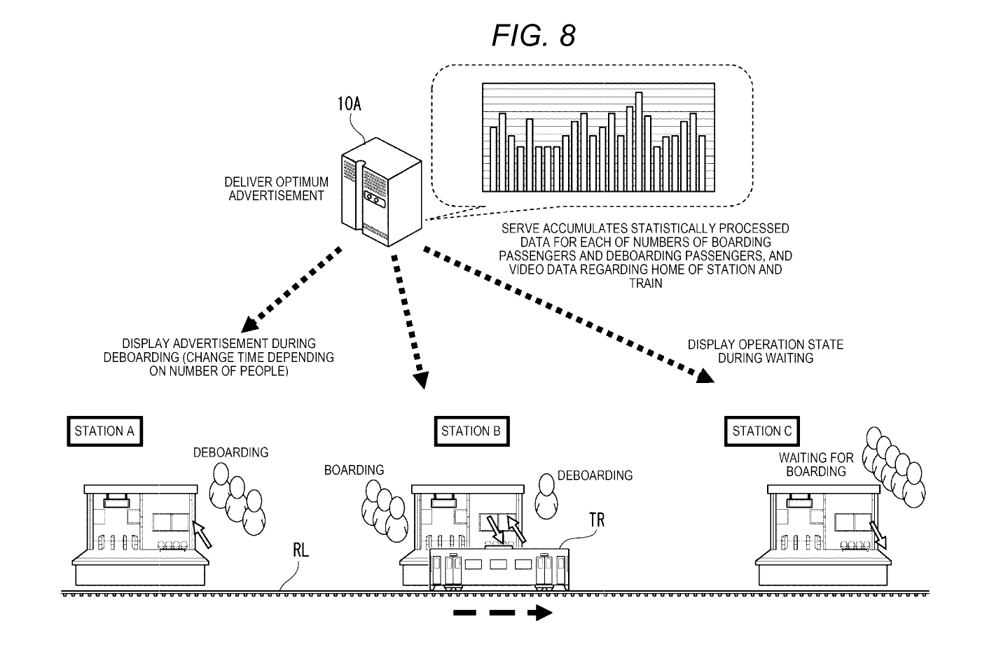

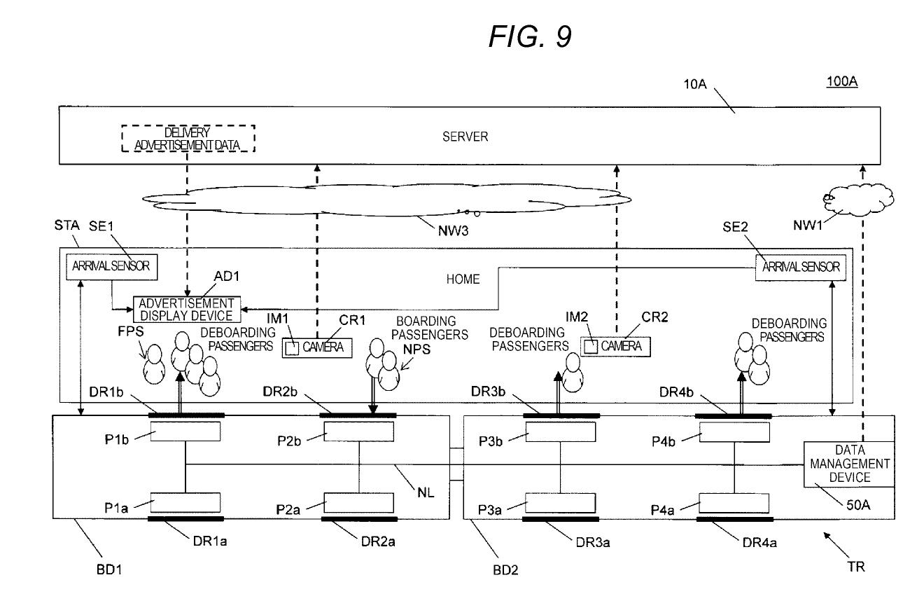

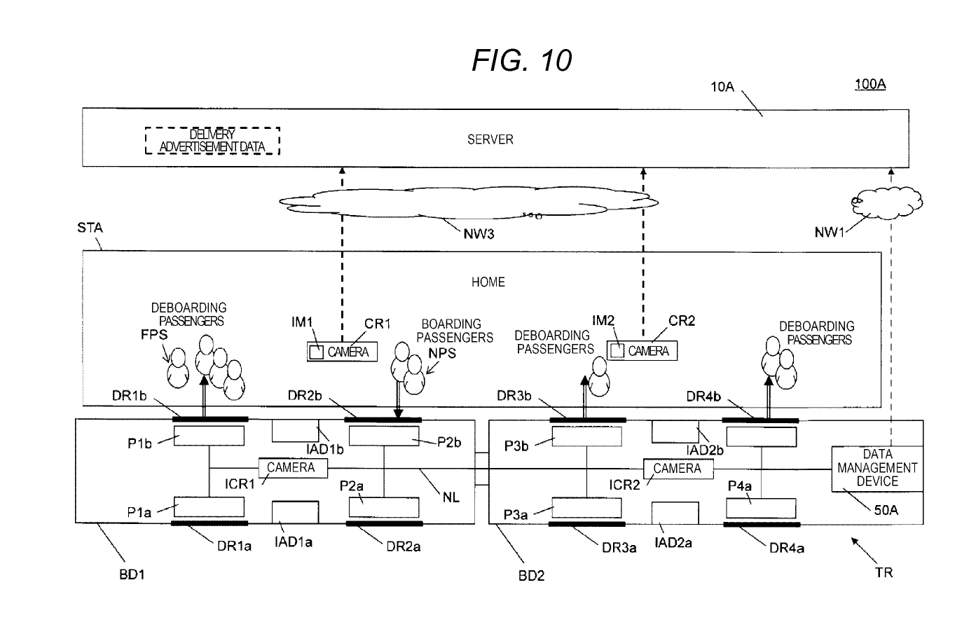

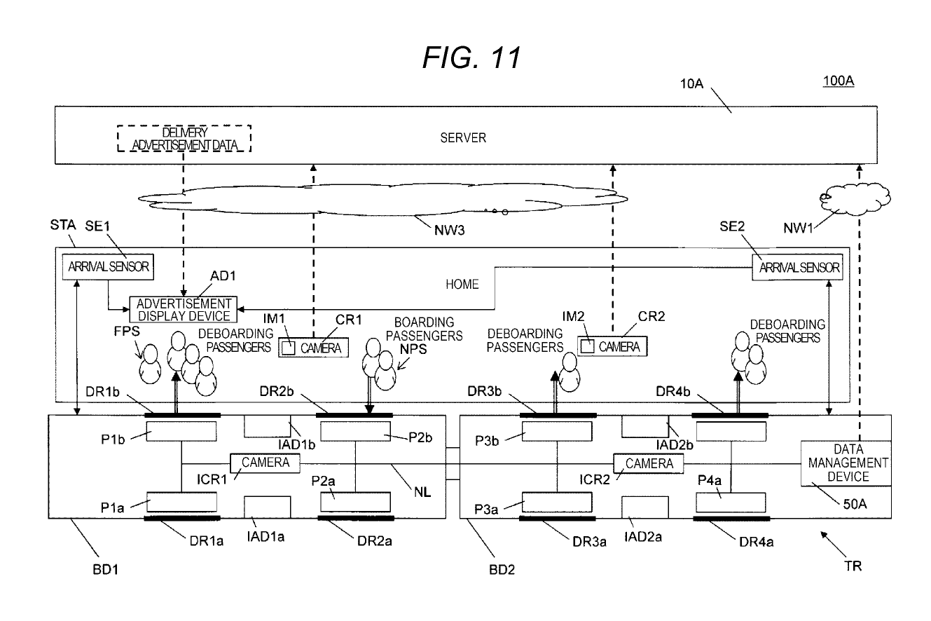

FIG. 8 is a diagram illustrating an operation summary of monitoring system 100A of a second exemplary embodiment. In the second exemplary embodiment, server 10A stores (accumulates) the statistically processed data regarding each of the number of deboarding people or the number of boarding people, and the video data regarding the home of stop or the video data regarding the home of the stop and the video data regarding the inside of railway vehicle TR, described in the first exemplary embodiment, and additionally stores (accumulates) delivery advertisement data which will be described later. In monitoring system 100A of the present exemplary embodiment, advertisement display devices (refer to FIGS. 9 and 11) which can display delivery advertisement data which is delivered from server 10A are provided in stops (station A, station B, and station C illustrated in FIG. 8), and advertisement display devices (refer to FIGS. 10 and 11) which can display delivery advertisement data which is delivered from server 10A are provided inside railway vehicle TR.

The advertisement display device provided in the stop displays delivery advertisement data which is delivered from server 10A in accordance with timing at which railway vehicle TR arrives at the stop and deboarding passengers FPS deboard the railway vehicle TR, and, as will be described later in detail, display content or display period of time of the delivery advertisement data is displayed in a changing manner depending on a time zone. The advertisement display device provided in the stop may display not only the delivery advertisement data but also, for example, operation state data to boarding passengers NPS who wait for boarding railway vehicle TR in a stop (for example, station C illustrated in FIG. 8) at which railway vehicle TR has not arrived yet.

FIG. 9 is a diagram illustrating an operation summary according to a first configuration example of monitoring system 100A of the second exemplary embodiment. FIG. 10 is a diagram illustrating an operation summary according to a second configuration example of monitoring system 100A of the second exemplary embodiment. FIG. 11 is a diagram illustrating an operation summary according to a third configuration example of monitoring system 100A of the second exemplary embodiment. FIGS. 9 to 11 illustrate, for example, a situation in which railway vehicle TR arrives at stop STA and automatic doors DR1b, DR2b, DR3b and DR4b are ready to be opened.

In description of each part illustrated in FIGS. 9 to 11, the same part as in the description of each part illustrated in FIG. 2 or 3 is given the same reference numeral, description thereof will be made briefly or omitted, and different content will be described. Also in the present exemplary embodiment, configuration examples of server 10A and data management device 50A are respectively the same as the configuration examples illustrated in FIGS. 4A and 4B.

Monitoring system 100A illustrated in FIG. 9 includes arrival sensors SE1 and SE2, number-of-people counting units P1a, P1b, P2a, P2b, P3a, P3b, P4a and P4b, data management device 50A, cameras CR1 and CR2, server 10A, and advertisement display device AD1.

Arrival sensors SE1 and SE2 radiate, for example, infrared light, and detects whether or not railway vehicle TR has stopped at a predetermined position of the home of stop STA depending on whether or not reflected light as a result of the infrared light being reflected by railway vehicle TR is received. Arrival sensors SE1 and SE2 may detect whether or not railway vehicle TR has stopped at a predetermined position of the home of the stop STA by using, for example, a magnetic sensor, instead of radiation of the infrared light. In a case where it is detected that railway vehicle TR has stopped at the predetermined position of stop STA, arrival sensors SE1 and SE2 output an arrival detection signal indicating that railway vehicle TR has stopped at the predetermined position of stop STA, to advertisement display device AD1.

Advertisement display device AD1, which is provided at a predetermined position of the home of stop STA, is connected to server 10A via network NW3, and displays delivery advertisement data which is delivered from server 10A, for a display period of time (reproduction period of time) specified by server 10A.

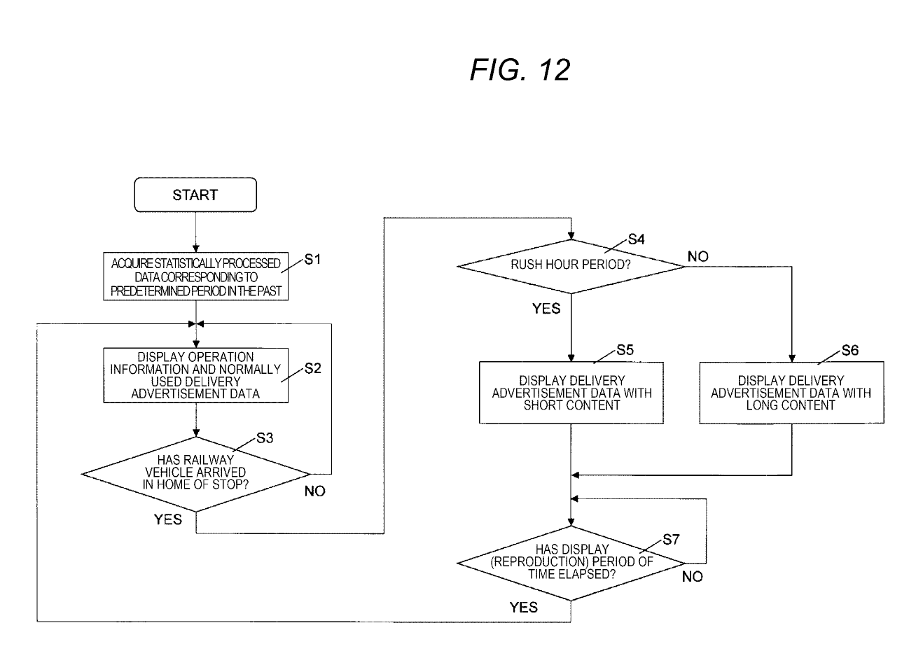

In a case where an arrival detection signal is input from either one or both of arrival sensors SE1 and SE2, advertisement display device AD1 displays delivery advertisement data which is delivered from server 10A, for a display period of time (reproduction period of time) specified by server 10A when railway vehicle TR has stopped at the predetermined position of the home of stop STA. Details of operations of advertisement display device AD1 and server 10A will be described later with reference to FIGS. 12 to 14.

Consequently, in a case where advertisement display device AD1 is provided at a predetermined position of the home of stop STA, monitoring system 100A of the present exemplary embodiment can display delivery advertisement data on advertisement display device AD1 toward boarding passengers NPS waiting for arrival of railway vehicle TR at stop STA or deboarding passengers FPS deboarding a railway vehicle which has arrived previously, for a display period of time (reproduction period of time) specified by server 10A.

In the present exemplary embodiment, as illustrated in FIG. 10, the advertisement display device may not be provided at a predetermined position of the home of stop STA but may be provided inside railway vehicle TR. In this case, server 10A delivers delivery advertisement data to data management device 50A via network NW1. Data management device 50A outputs the delivery advertisement data which is delivered from server 10A, to advertisement display devices IAD1a, IAD1b, IAD2a and IAD2b.

Consequently, even if advertisement display device AD1 is not provided at a predetermined position of the home of stop STA, monitoring system 100A of the present exemplary embodiment can display delivery advertisement data which is delivered from server 10A on advertisement display devices IAD1a, IAD1b, IAD2a and IAD2b provided inside railway vehicle TR, for a display period of time (reproduction period of time) specified by server 10A.

In the present exemplary embodiment, as illustrated in FIG. 11, the advertisement display device may be provided not only at a predetermined position of the home of stop STA but also inside railway vehicle TR. In this case, server 10A delivers delivery advertisement data to advertisement display device AD1 via network NW3, and also delivers the delivery advertisement data to data management device 50A via network NW1. Data management device 50A outputs the delivery advertisement data which is delivered from server 10A, to advertisement display devices IAD1a, IAD1b, IAD2a and IAD2b.

Consequently, in a case where advertisement display device AD1 is provided at a predetermined position of the home of stop STA, and advertisement display devices IAD1a, IAD1b, IAD2a and IAD2b are provided inside railway vehicle TR, monitoring system 100A of the present exemplary embodiment can display delivery advertisement data on advertisement display device AD1 toward boarding passengers NPS waiting for arrival of railway vehicle TR at stop STA or deboarding passengers FPS deboarding a railway vehicle which has arrived previously, for a display period of time (reproduction period of time) specified by server 10A.

Monitoring system 100A can display the delivery advertisement data on advertisement display devices IAD1a, IAD1b, IAD2a and IAD2b toward passengers (including deboarding passengers FPS who will deboard in the next stop) inside railway vehicle TR for a display period of time (reproduction period of time) specified by server 10A. Display periods of time for which advertisement display device AD1 and advertisement display devices IAD1a, IAD1b, IAD2a and IAD2b display delivery advertisement data may or not be the same as each other, and content items of the delivery advertisement data may or not be the same as each other.

In FIG. 11, for simplification of the drawings, arrows between advertisement display devices IAD1a, IAD1b, IAD2a and IAD2b and data management device 50A are not illustrated.

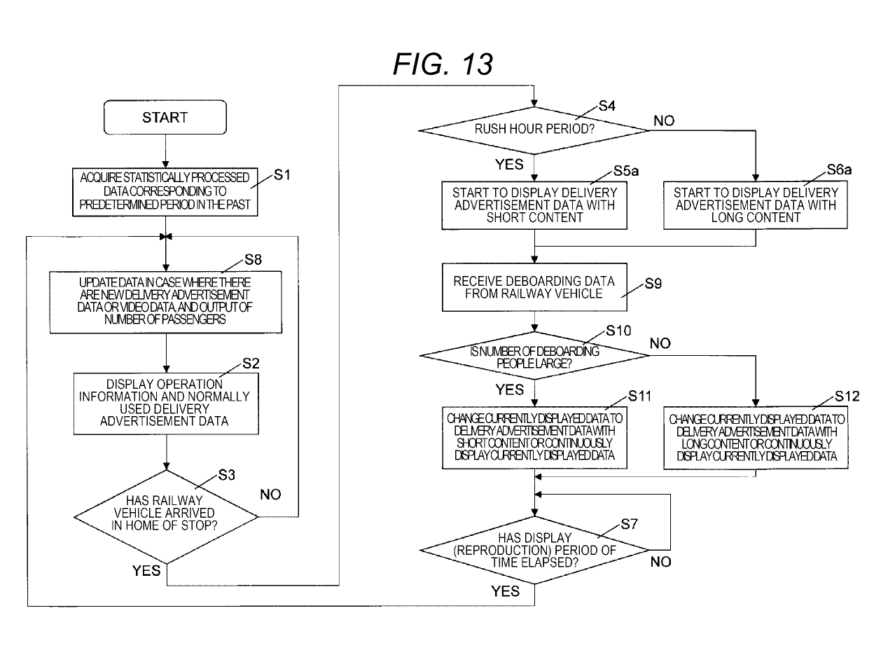

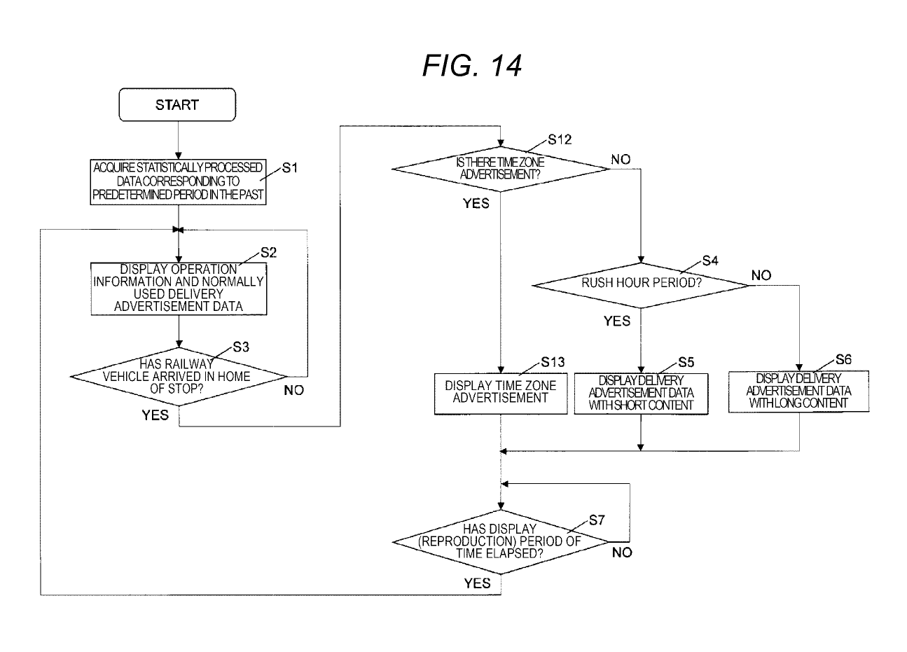

Next, with reference to FIGS. 12 to 14, a description will be made of a first operation procedure to a third operation procedure in server 10A and the advertisement display device (for example, advertisement display device AD1) of monitoring system 100A of the present exemplary embodiment. FIG. 12 is a flowchart illustrating a first operation example of monitoring system 100A of the second exemplary embodiment. FIG. 13 is a flowchart illustrating a second operation example of monitoring system 100A of the second exemplary embodiment. FIG. 14 is a flowchart illustrating a third operation example of monitoring system 100A of the second exemplary embodiment. Each of the flowcharts illustrated in FIGS. 12 to 14 may correspond to an operation procedure in any one of monitoring systems 100A illustrated in FIGS. 9 to 11.

In FIG. 12, first, server 10A reads and acquires, for example, statistically processed data corresponding to one week in the past from the present time as statistically processed data in a predetermined period in the past, from storage unit 13 (step S1). The statistically processed data is assumed to be, for example, a time zone-basis number of deboarding passengers FPS in a specific stop. The predetermined period in the past is not limited to one week, and may be one month or one year.

Server 10A extracts and reads, from storage unit 13, delivery advertisement data (for example, delivery advertisement data which was ever used in the same period in the past) which is suitable as delivery advertisement data at the present time, on the basis of the delivery advertisement data in the predetermined period in the past, acquired in step S1. Here, the selected delivery advertisement data is formed of, for example, a set of operation information indicating an operation state on a schedule including the present time and normally used delivery advertisement data.

Server 10A extracts and read, from storage unit 13, delivery advertisement data which is displayed (reproduced) in a predetermined rush hour period which will be described later and delivery advertisement data which is displayed (reproduced) in a period (for example, an off-hour period) excluding the rush hour period. The delivery advertisement data displayed (reproduced) in the rush hour period is advertisement having content of which a display period of time is short. On the other hand, the delivery advertisement data displayed (reproduced) in a period (for example, an off-hour period) excluding the rush hour period is advertisement having content of which a display period of time is long.

In other words, since there are a large number of passengers (deboarding passengers FPS and boarding passengers NPS) in the home of stop STA in the rush hour period, advertisement having a short display period of time may be more effective than advertisement having a long display period of time in a time zone in which many people go in and out in that the advertisement having a short display period of time is seen by a large number of people. On the other hand, since there are a few passengers (deboarding passengers FPS and boarding passengers NPS) in the home of stop STA in a period (for example, an off-hour period) excluding the rush hour period, advertisement having a long display period of time may be more effective than advertisement having a short display period of time in a time zone in which a few people go in and out in that the advertisement having a long display period of time is seen well.

Server 10A delivers the extracted delivery advertisement data and information regarding a display (reproduction) period of time of the delivery advertisement data to advertisement display device AD1 via network NW3. For a period of time corresponding to the information regarding the display (reproduction) period of time delivered from server 10A, advertisement display device AD1 displays the delivery advertisement data delivered from server 10A, that is, the set data of operation information indicating an operation state on a schedule including the present time and normally used delivery advertisement data (step S2).

After step S2, if railway vehicle TR has not arrived in the home of stop STA (NO in step S3), advertisement display device AD1 repeatedly displays the delivery advertisement data delivered from server 10A for the period of time corresponding to the information regarding the display (reproduction) period of time delivered from server 10A (step S2). Advertisement display device AD1 can easily determine whether or not railway vehicle TR has arrived in the home of stop STA on the basis of whether or not an arrival detection signal is output from arrival sensors SE1 and SE2.

On the other hand, after step S2, if railway vehicle TR has arrived in the home of stop STA (YES in step S3), advertisement display device AD1 determines whether or not the present time is a predetermined rush hour period (for example, a period between 7 a.m. to 10 a.m. or a period between 5 p.m. and 8 p.m., which is the same for the following description) (step S4).

If it is determined that the present time is a predetermined rush hour period (YES in step S4), advertisement display device AD1 changes currently displayed data to delivery advertisement data of which a display (reproduction) period of time is short and which is then displayed, among delivery advertisement data items delivered from server 10A (step S5).

On the other hand, it is determined that the present time is not a predetermined rush hour period (NO in step S4), advertisement display device AD1 changes currently displayed data to delivery advertisement data of which a display (reproduction) period of time is long and which is then displayed, among delivery advertisement data items delivered from server 10A (step S6).

After step S5 or step S6, if the display (reproduction) period of time of the delivery advertisement data displayed in step S5 or S6 has elapsed (YES in step S7), the operation of advertisement display device AD1 returns to step S2. In other words, advertisement display device AD1 displays the set data of operation information indicating an operation state on a schedule including the present time and normally used delivery advertisement data (step S2).

As described above, in monitoring system 100A of the present exemplary embodiment, in a case where railway vehicle TR has not arrived at stop STA, advertisement display device AD1 continuously displays operation information indicating an operation state of railway vehicle TR and normally used delivery advertisement data (for example, advertisement data regarding a store around stop STA). In a case where railway vehicle TR has arrived at stop STA, advertisement display device AD1 changes the data to delivery advertisement data having different display (reproduction) periods of time, and continuously displays the delivery advertisement data for a display (reproduction) period of time corresponding to the delivery advertisement data.

Consequently, monitoring system 100A can positively and explicitly show and introduce business opportunities of providing goods or services to passengers (including deboarding passengers FPS and boarding passengers NPS) present in stop STA on the basis of whether or not railway vehicle TR has arrived at stop STA and whether or not the present time is a rush hour period.

In FIG. 13, in a case where server 10A receives new video data and data regarding counted numbers of deboarding people and boarding people which are output from cameras CR1 and CR2 and data management device 50A, or an operation for storing new delivery advertisement data is performed, server 10A performs data update on storage unit 13 (step S8).

If it is determined that the present time is a predetermined rush hour period (YES in step S4), after step S8, advertisement display device AD1 changes currently displayed data to delivery advertisement data of which a display (reproduction) period of time is short and which is then displayed, among delivery advertisement data items delivered from server 10A (step S5a).

On the other hand, it is determined that the present time is not a predetermined rush hour period (NO in step S4), advertisement display device AD1 changes currently displayed data to delivery advertisement data of which a display (reproduction) period of time is long and which then starts to be displayed, among delivery advertisement data items delivered from server 10A (step S6a).

After the delivery advertisement data starts to be displayed in step S5a or step S6a, server 10A is assumed to receive deboarding data from railway vehicle TR (step S9). The deboarding data is information regarding the number of deboarding passengers FPS, which is counted by, for example, the number-of-people counting units (for example, number-of-people counting units P1b, P2b, P3b and P4b) provided inside railway vehicle TR. Server 10A determines whether or not the number of deboarding people in the deboarding data received in step S9 is larger than a predetermined threshold value (step S10).

If it is determined that the number of deboarding people in the deboarding data received in step S9 is larger than a predetermined threshold value (YES in step S10), server 10A causes advertisement display device AD1 to continuously display the delivery advertisement data with short content, starting to be displayed in step S5a, or to change the delivery advertisement data with long content, starting to be displayed in step S6a, to delivery advertisement data with short content which is then displayed (step S11).

On the other hand, if it is determined that the number of deboarding people in the deboarding data received in step S9 is equal to or smaller than a predetermined threshold value (NO in step S10), server 10A causes advertisement display device AD1 to continuously display the delivery advertisement data with long content, starting to be displayed in step S6a, or to change the delivery advertisement data with short content, starting to be displayed in step S5a, to delivery advertisement data with long content which is then displayed (step S12).

As mentioned above, in monitoring system 100A of the present exemplary embodiment, in addition to the operation illustrated in the flowchart of FIG. 12, server 10A performs data update in a case where new delivery advertisement data is added, or in a case where output data regarding counted numbers of deboarding people and boarding people is received. In a case where delivery advertisement data is temporarily starts to be displayed, and then server 10A receives deboarding data, advertisement display device AD1 changes the currently displayed data to delivery advertisement data with short content or continuously displays the currently displayed data, or changes the currently displayed data to delivery advertisement data with long content or continuously displays the currently displayed data, depending on whether the number of deboarding people indicated by the deboarding data is small or large, in response to an instruction from server 10A.

Consequently, in a case where delivery advertisement data is temporarily starts to be displayed, and then server 10A receives deboarding data, monitoring system 100A can positively and explicitly show and introduce business opportunities of providing goods or services to passengers (including deboarding passengers FPS and boarding passengers NPS) present in stop STA on the basis of the number of deboarding people FPS indicated by the latest deboarding data.

In FIG. 14, after step S2, if railway vehicle TR has arrived in the home of stop STA (YES in step S3), advertisement display device AD1 determines whether or not time zone advertisement data is received from server 10A (step S12). The time zone advertisement data is advertisement which presents effective content to passengers (including deboarding passengers FPS and boarding passengers NPS) present in stop STA in a specific time zone, and may include, for example, an evening time service.

If time zone advertisement data is not received from server 10A (NO in step S12), advertisement display device AD1 determines whether or not the present time is a predetermined rush hour period (for example, a period between 7 a.m. to 10 a.m. or a period between 5 p.m. and 8 p.m., which is the same for the following description) (step S4).

On the other hand, if time zone advertisement data is received from server 10A (YES in step S12), advertisement display device AD1 displays delivery advertisement data delivered from server 10A for a display period of time corresponding to a display (reproduction) period of time delivered from server 10A, in accordance with the present time (step S13).

As mentioned above, in monitoring system 100A of the present exemplary embodiment, in addition to the operation illustrated in the flowchart of FIG. 12, advertisement display device AD1 selects and displays time zone advertisement data in accordance with the present time in response to an instruction from server 10A in a case where time zone advertisement data is delivered from server 10A.

Consequently, in a case where server 10A delivers time zone advertisement data whose content specific to a time zone is taken into consideration to advertisement display device AD1, monitoring system 100A can display delivery advertisement data with the optimal content in accordance with the present time on advertisement display device AD1, and can thus positively and explicitly show and introduce business opportunities of providing goods or services to passengers (including deboarding passengers FPS and boarding passengers NPS) present in stop STA on the basis of the number of deboarding people indicated by the latest deboarding data.

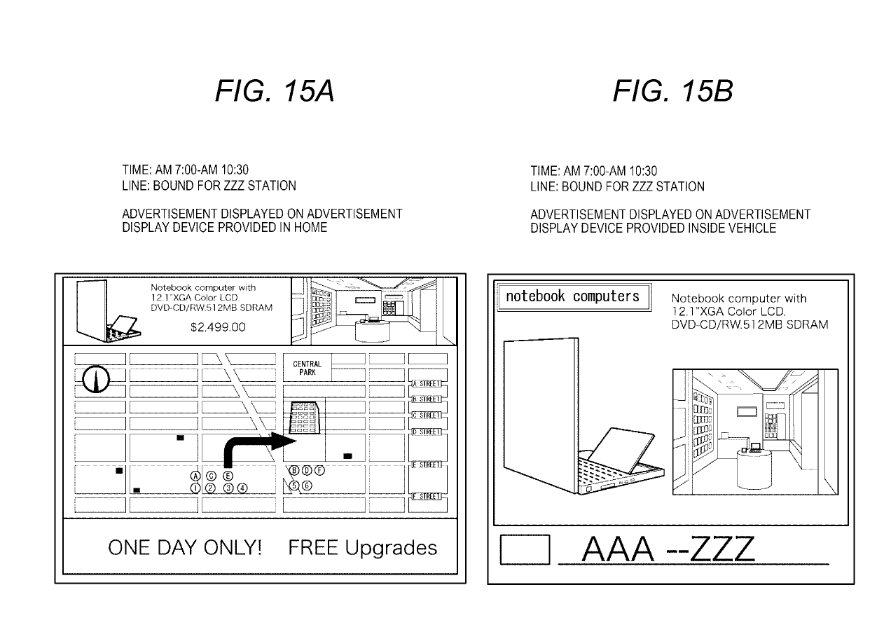

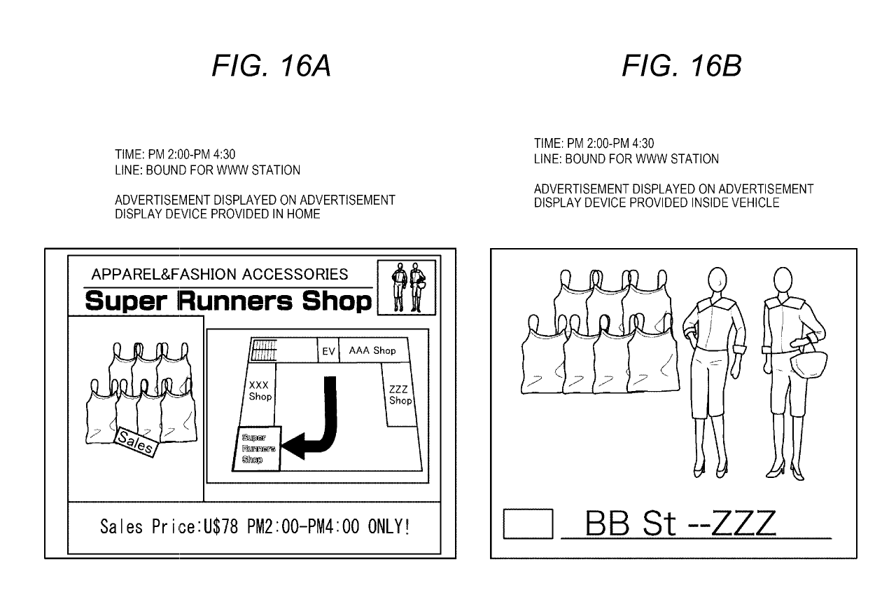

FIG. 15A is a diagram illustrating an example of delivery advertisement data which is displayed on advertisement display device AD1 provided in a home related to railway vehicle TR bound for “ZZZ” Station from 7 a.m. to 10:30 a.m. FIG. 15B is a diagram illustrating an example of delivery advertisement data which is displayed on advertisement display device AD1 provided inside railway vehicle TR bound for “ZZZ” Station from 7 a.m. to 10:30 a.m. FIG. 16A is a diagram illustrating an example of delivery advertisement data which is displayed on advertisement display device AD1 provided in a home related to railway vehicle TR bound for “WWW” Station from 2 p.m. to 4:30 p.m. FIG. 16B is a diagram illustrating an example of delivery advertisement data which is displayed on advertisement display device AD1 provided inside railway vehicle TR bound for “WWW” Station from 2 p.m. to 4:30 p.m.

Server 10A displays an advertisement for the “ZZZ” Station yard and an advertisement for a computer shop in the “ZZZ” Station yard together on an advertisement display device (for example, advertisement display device AD1) provided in any one (for example, stop STA) of stops at which railway vehicle TR bound for “ZZZ” Station stops from 7 a.m. to 10:30 a.m., for example, in a case where it is determined that the number of deboarding people is equal to or larger than a predetermined number (refer to FIG. 15A).

Server 10A displays the advertisement for the computer shop in the “ZZZ” Station yard on advertisement display devices (for example, advertisement display devices IAD1a and IAD1b) provided inside railway vehicle TR bound for “ZZZ” Station stops from 7 a.m. to 10:30 a.m., for example, in a case where it is determined that the number of deboarding people is equal to or larger than a predetermined number (refer to FIG. 15B).

Server 10A displays an advertisement for the “WWW” Station yard and an advertisement for an apparel shop in the “WWW” Station yard together on advertisement display devices (for example, advertisement display device AD1) provided in any one (for example, stop STA) of stops at which railway vehicle TR bound for “WWW” Station stops from 2 p.m. to 4:30 p.m., for example, in a case where it is determined that the number of deboarding people is equal to or larger than a predetermined number (refer to FIG. 16A).

Server 10A displays the advertisement for the apparel shop in the “WWW” Station yard together on an advertisement display device (for example, advertisement display devices IAD1a and IAD1b) provided inside railway vehicle TR bound for “WWW” Station stops from 2 p.m. to 4:30 p.m., for example, in a case where it is determined that the number of deboarding people is equal to or larger than a predetermined number (refer to FIG. 16B).

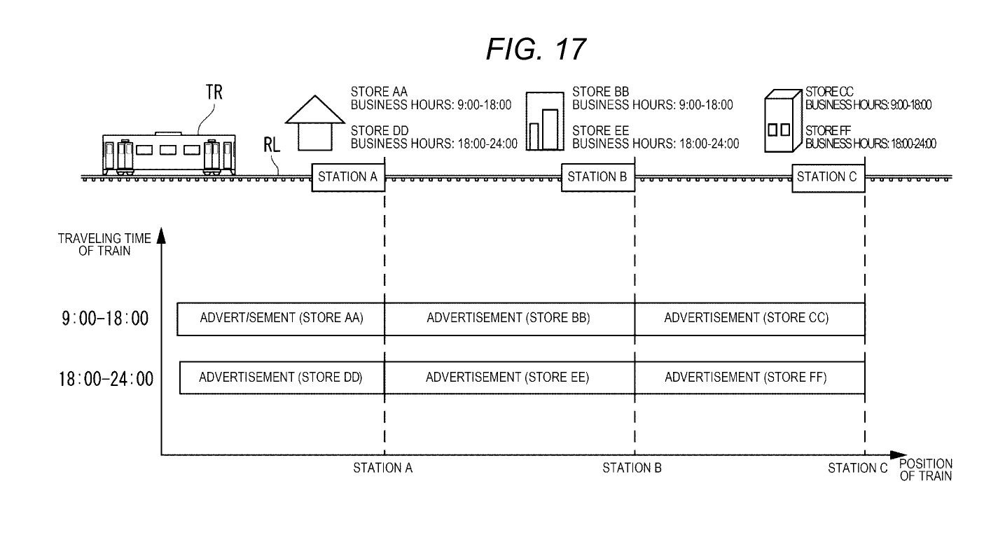

Next, with reference to FIG. 17, a description will be made of a fourth operation procedure in server 10A of monitoring system 100A of the present exemplary embodiment and an advertisement display device provided in each stop. FIG. 17 is an operation summary diagram illustrating a fourth operation example of the monitoring system of the second exemplary embodiment.

In FIG. 17, server 10A changes and displays delivery advertisement data to be displayed on advertisement display devices (for example, advertisement display device IAD1a and IAD1b) provided inside railway vehicle TR in correlation with an advertisement for a stop yard or the vicinity of the stop yard on the basis of a traveling situation of railway vehicle TR and a time zone.

For example, as illustrated in FIG. 17, railway vehicle TR travels through station A, station B, and station C in this order. An advertisement display device (for example, advertisement display device AD1) provided in a home of station A is displaying delivery advertisement data regarding store AA and store DD located in the yard of station A. An advertisement display device provided in a home of station B is displaying delivery advertisement data regarding store BB and store EE located in the yard of station B. An advertisement display device provided in a home of station C is displaying delivery advertisement data regarding store CC and store FF located in the yard of station C.

The business hours of store AA are 9 a.m. to 6 p.m., and the business hours of store DD are 6 p.m. to 0 a.m. The business hours of store BB are 9 a.m. to 6 p.m., and the business hours of store EE are 6 p.m. to 0 a.m. Similarly, The business hours of store CC are 9 a.m. to 6 p.m., and the business hours of store FF are 6 p.m. to 0 a.m. It is assumed that data items regarding the business hours of stores AA, BB, CC, DD, EE and FF are stored in storage unit 13 of server 10A.

Server 10A displays delivery advertisement data regarding store AA on and advertisement display device (for example, advertisement display device AD1) provided in the home of station A from 9 a.m. to 6 p.m., and displays delivery advertisement data regarding store DD thereon from 6 p.m. to 0 a.m. Server 10A displays delivery advertisement data regarding store BB on and advertisement display device provided in the home of station B from 9 a.m. to 6 p.m., and displays delivery advertisement data regarding store EE thereon from 6 p.m. to 0 a.m. Similarly, server 10A displays delivery advertisement data regarding store CC on and advertisement display device provided in the home of station C from 9 a.m. to 6 p.m., and displays delivery advertisement data regarding store FF thereon from 6 p.m. to 0 a.m.

On the basis of the traveling situation of railway vehicle TR and the time zone illustrated in FIG. 17, from 9 a.m. to 6 p.m., server 10A displays the delivery advertisement data regarding store AA on advertisement display devices (for example, advertisement display device IAD1a and IAD1b) provided inside railway vehicle TR until railway vehicle TR arrives at station A; displays the delivery advertisement data regarding store BB on advertisement display devices (for example, advertisement display device IAD1a and IAD1b) provided inside railway vehicle TR until railway vehicle TR arrives at station B after departing from station A; and displays the delivery advertisement data regarding store CC on advertisement display devices (for example, advertisement display device IAD1a and IAD1b) provided inside railway vehicle TR until railway vehicle TR arrives at station C after departing from station B.

Similarly, on the basis of the traveling situation of railway vehicle TR and the time zone illustrated in FIG. 17, from 6 p.m. to 0 a.m, server 10A displays the delivery advertisement data regarding store DD on advertisement display devices (for example, advertisement display device IAD1a and IAD1b) provided inside railway vehicle TR until railway vehicle TR arrives at station A; displays the delivery advertisement data regarding store EE on advertisement display devices (for example, advertisement display device IAD1a and IAD1b) provided inside railway vehicle TR until railway vehicle TR arrives at station B after departing from station A; and displays the delivery advertisement data regarding store FF on advertisement display devices (for example, advertisement display device IAD1a and IAD1b) provided inside railway vehicle TR until railway vehicle TR arrives at station C after departing from station B.

As described above, in monitoring system 100A of the present exemplary embodiment, server 10A changes and displays delivery advertisement data to be displayed on advertisement display devices (for example, advertisement display device IAD1a and IAD1b) provided inside railway vehicle TR in correlation with an advertisement for a stop yard or the vicinity of the stop yard on the basis of a traveling situation of railway vehicle TR and a time zone.

Consequently, monitoring system 100A displays an advertisement with a high relevance with the business hours and the traveling time of railway vehicle TR on the advertisement display devices provided inside railway vehicle TR, and thus it is possible to effectively explicitly show delivery advertisement data which may attract a great deal of attention of passengers (including deboarding passengers FPS and boarding passengers NPS) in railway vehicle TR.

The present exemplary embodiment has been described by using examples of a railway vehicle, a stop, and a home, but is not limited to a railway vehicle, a stop, and a home, and may be an exemplary embodiment in which an advertisement display device provided inside a bus or near a bus stop is controlled by using the number of people deboarding the bus under the use environment in the bus, the bus stop, and the vicinity of the bus stop.

The monitoring system of the present exemplary embodiment is not limited to a railway vehicle and a bus and is applicable to moving objects including, for example, an airplane and a ship as described above. For example, the present exemplary embodiment may be an exemplary embodiment in which an advertisement display device provided inside a moving object or near a location at which the moving object arrives is controlled by using the number of people getting of the moving object under the use environment in the moving object, the location at which the moving object arrives, the vicinity of a predetermined process of the location at which the moving object arrives.

Although the various exemplary embodiments have been described with reference to the drawings, needless to say, the present invention is not limited to such exemplary embodiments. It is obvious that a person skilled in the art can conceive of various modifications or alterations within the scope recited in the claims, and thus it is understood that they naturally fall within the technical scope of the present invention.

What is claimed is:

1. A monitoring system comprising:
a number-of-people counting unit that is provided inside a moving object and counts the number of people deboarding the moving object;
a first camera that is provided in a location in which people deboard the moving object and captures images of people who deboard the moving object which has arrived at a predetermined position of the location or has arrived at the location; and
a server that stores information regarding the number of people counted by the number-of-people counting unit and video data regarding the people captured by the first camera in correlation with each other.

2. A monitoring system comprising:
a number-of-people counting unit that is provided inside a railway vehicle and counts the number of deboarding passengers who deboard the railway vehicle;
a first camera that is provided in a stop of the railway vehicle and captures images of deboarding passengers who deboard the railway vehicle which has arrived in a home of the stop or has arrived at the stop; and
a server that stores information regarding the number of deboarding passengers counted by the number-of-people counting unit and video data regarding the deboarding passengers captured by the first camera in correlation with each other.

3. The monitoring system of claim 2, further comprising:
a second camera that is provided inside the railway vehicle and captures an image of inside of the railway vehicle,
wherein the server stores video data regarding the inside of the railway vehicle, captured by the second camera, in correlation with the data stored therein, while the railway vehicle is stopping at the stop.

4. The monitoring system of claim 3,
wherein the first camera includes an image processing unit that detects the deboarding passengers on the basis of the video data regarding the deboarding passengers, and
wherein the first camera transmits, to the server, information regarding deboarding time at which the deboarding passengers deboard the railway vehicle, information regarding the number of deboarding passengers detected by the image processing unit, and video data regarding the home in a predetermined period including a time at which a door of the railway vehicle is opened.

5. The monitoring system of claim 4,
wherein the second camera transmits, to the server, video data regarding the inside of the railway vehicle in the predetermined period including the time at which the door of the railway vehicle is opened.

6. The monitoring system of claim 2, further comprising:
a statistical processing unit that generates first statistically processed information indicating information regarding the number of deboarding passengers for each time zone in a specific stop; and
a display unit that displays the first statistically processed information generated by the statistical processing unit,
wherein the display unit displays video data regarding the deboarding passengers in a designated time zone in response to an operation of designating any time zone of the first statistically processed information in the specific stop.

7. The monitoring system of claim 6, further comprising:
a second camera that is provided inside the railway vehicle and captures an image of the inside of the railway vehicle,
wherein the server stores video data regarding the inside of the railway vehicle, captured by the second camera, in correlation with the data stored therein, while the railway vehicle is stopping at the stop, and
wherein the display unit displays the video data regarding the inside of the railway vehicle in a designated time zone.

8. The monitoring system of claim 2,
wherein the number-of-people counting unit counts the number of boarding passengers who board the railway vehicle which has arrived at the stop, and
wherein the server stores information regarding the number of boarding passengers counted by the number-of-people counting unit in correlation with the data stored therein.

9. The monitoring system of claim 2, further comprising:
a first advertisement display unit that is provided in a stop of the railway vehicle, and displays advertisement data regarding the stop,
wherein the server changes a display period of time of the advertisement data which is delivered to the first advertisement display unit, depending on information regarding the number of deboarding passengers counted by the number-of-people counting unit.

10. The monitoring system of claim 8, further comprising:
a second advertisement display unit that is provided inside the railway vehicle, and displays advertisement data regarding the stop,
wherein the server changes a display period of time of the advertisement data which is delivered to the second advertisement display unit, depending on information regarding the number of boarding passengers counted by the number-of-people counting unit.

11. The monitoring system of claim 2, further comprising:
a first advertisement display unit that is provided in a stop of the railway vehicle, and displays advertisement data regarding the stop,
wherein the server changes content of the advertisement data which is delivered to the first advertisement display unit, depending on a time zone in which the railway vehicle arrives at the stop.

12. The monitoring system of claim 8, further comprising:
a second advertisement display unit that is provided inside the railway vehicle, and displays advertisement data regarding the stop,
wherein the server changes content of the advertisement data which is delivered to the second advertisement display unit, depending on a time zone in which the railway vehicle arrives at the stop.

13. The monitoring system of claim 2, further comprising:
a first advertisement display unit that is provided in a stop of the railway vehicle, and displays advertisement data regarding the stop; and
a second advertisement display unit that is provided inside the railway vehicle, and displays advertisement data regarding the stop,
wherein the server changes content of the advertisement data which is delivered to the first advertisement display unit and the second advertisement display unit, depending on the next stop at which the railway vehicle arrives next.

14. The monitoring system of claim 13,
wherein the server changes content of the advertisement data which is delivered to the first advertisement display unit and the second advertisement display unit, depending on a time zone in which the railway vehicle arrives at the next stop.

15. The monitoring system of claim 8, further comprising:
a statistical processing unit that generates second statistically processed information indicating information regarding the number of boarding passengers for each time zone in a specific stop; and
a display unit that displays the second statistically processed information generated by the statistical processing unit,
wherein the display unit displays video data regarding the boarding passengers in a designated time zone in response to an operation of designating any time zone of the second statistically processed information in the specific stop.

16. The monitoring system of claim 8, further comprising:
a statistical processing unit that generates third statistically processed information indicating information regarding the number of boarding passengers for each stop in a specific time zone; and
a display unit that displays the third statistically processed information generated by the statistical processing unit,
wherein the display unit displays video data regarding the boarding passengers in a designated stop in response to an operation of designating any stop of the third statistically processed information in the specific time zone.

17. The monitoring system of claim 2, further comprising:
a statistical processing unit that generates fourth statistically processed information indicating information regarding the number of deboarding passengers for each time zone in some or all stops on a stop map indicating the stops at which the railway vehicle stops; and
a display unit that displays the fourth statistically processed information generated by the statistical processing unit,
wherein the display unit displays video data regarding the deboarding passengers in a designated stop in response to an operation of designating any stop of the fourth statistically processed information in a specific stop on the stop map displayed on the display unit.

18. The monitoring system of claim 8, further comprising:
a statistical processing unit that generates fifth statistically processed information indicating information regarding the number of boarding passengers for each time zone in some or all stops on a stop map indicating the stops at which the railway vehicle stops; and
a display unit that displays the fifth statistically processed information generated by the statistical processing unit,
wherein the display unit displays video data regarding the boarding passengers in a designated stop in response to an operation of designating any stop of the fifth statistically processed information in a specific stop on the stop map displayed on the display unit.

19. A monitoring method in a monitoring system which monitors people deboarding a moving object in a location at which the moving object arrives, the method comprising:
detecting that the moving object has arrived at the location;
counting the number of people deboarding the moving object;
causing a first camera that is provided in the location to capture images of people who deboard the moving object which has arrived at the location; and
storing information regarding the counted number of people and video data regarding the people captured by the first camera in correlation with each other.

20. A monitoring method in a monitoring system which monitors deboarding passengers who deboard a railway vehicle in a stop at which the railway vehicle stops, the method comprising:
detecting that the railway vehicle has arrived at the stop;
counting the number of deboarding passengers who deboard the railway vehicle;
causing a first camera that is provided in the stop of the railway vehicle to capture images of deboarding passengers who deboard the railway vehicle which has arrived at the stop; and
storing information regarding the counted number of deboarding passengers and video data regarding the deboarding passengers captured by the first camera in correlation with each other.
